(19) United States
(12) Patent Application Publication
(10) Pub. No.: US 2018/0032638 A1
(43) Pub. Date: Feb. 1, 2018

(54) Surface Analysis Systems and Methods of Generating a Comparator Surface Reference Model of a Multi-Part Assembly Using the Same

(71) Applicant: Toyota Motor Engineering & Manufacturing North America, Inc., Erlanger, KY (US)

(72) Inventor: Aaron Burton, Fort Wright, KY (US)

(73) Assignee: Toyota Motor Engineering & Manufacturing North America, Inc., Erlanger, KY (US)

(21) Appl. No.: 15/221,136

(22) Filed: Jul. 27, 2016

(51) Int. Cl. G06F 17/50; G06F 1/16

(52) U.S. Cl. CPC G06F 17/50; G06F 1/163

(57) ABSTRACT

A surface analysis system that includes one or more processors and one or more memory modules. The surface analysis system identifies one or more visible surface segments of a first part of a first multi-part assembly that includes a second part having one or more hidden surface segments. The surface analysis system also classifies the one or more visible surface segments of the first part as comparator surfaces, determines a segment spacing distance between at least one hidden surface segment of the second part and the first part, classifies the one or more hidden surface segments of the second part positioned adjacent and unobstructed from the first part that have a segment spacing distance less than or equal to a threshold spacing distance as comparator surfaces, and generates a comparator surface reference model corresponding with the one or more comparator surfaces.

### TECHNICAL FIELD

Embodiments described herein generally relate to surface analysis systems and, more specifically, methods and systems for generating a comparator surface reference model of a multi-part assembly, such as a vehicle.

### BACKGROUND

When designing and manufacturing products, such as vehicles, reference models of the products may be created to provide a quality control reference. However, comparing a product having many parts with many surfaces to a reference model may be time consuming and inefficient.

Accordingly, a need exists for systems and methods for generating comparator surface reference models that include a subset of the part surfaces of a product.

### SUMMARY

In one embodiment, a surface analysis system includes one or more processors, one or more memory modules communicatively coupled to the one or more processors, and machine readable instructions stored in the one or more memory modules that cause the surface analysis system to perform at least the following when executed by the one or more processors: identify one or more visible surface segments of a first part of a first multi-part assembly. The one or more visible surface segments of the first part are located unobstructed from at least one discrete observation location within an observation environment. The second part includes one or more hidden surface segments located obstructed from at least one discrete observation location within the observation environment. Further, at least one hidden surface segments of the second part is positioned adjacent and unobstructed from the first part. The machine readable instructions stored in the one or more memory modules further cause the surface analysis system to classify the one or more visible surface segments of the first part as comparator surfaces of the first multi-part assembly, determine a segment spacing distance between at least one hidden surface segment of the second part and the first part; classify the one or more hidden surface segments of the second part positioned adjacent and unobstructed from the first part that have a segment spacing distance less than or equal to a threshold spacing distance as one or more comparator surfaces of the first multi-part assembly, and generate a comparator surface reference model corresponding with the one or more comparator surfaces of the first multi-part assembly.

In another embodiment, a method of generating a comparator surface reference model of a first multi-part assembly includes identifying one or more visible surface segments of a first part of a first multi-part assembly. The one or more visible surface segments of the first part are located unobstructed from at least one discrete observation location within an observation environment. The second part includes one or more hidden surface segments located obstructed from at least one discrete observation location within the observation environment. Further, at least one hidden surface segment of the second part is positioned adjacent and unobstructed from the first part. The method further includes classifying the one or more visible surface segments of the first part as one or more comparator surfaces of the first multi-part assembly, determining a segment spacing distance between at least one hidden surface segments of the second part and the first part, classifying the one or more hidden surface segments of the second part positioned adjacent and unobstructed from the first part that have a segment spacing distance less than or equal to a threshold spacing distance as one or more comparator surfaces of the first multi-part assembly, and generating, using one or more processors, a comparator surface reference model corresponding with the one or more comparator surfaces of the first multi-part assembly.

In yet another embodiment, a surface analysis system includes one or more processors, one or more memory modules communicatively coupled to the one or more processors, and machine readable instructions stored in the one or more memory modules that cause the surface analysis system to perform at least the following when executed by the one or more processors: identify one or more visible surface segments of a first part of a multi-part assembly that further includes a second part. The one or more visible surface segments of the first part are located unobstructed from at least one discrete observation location within an observation environment. The second part includes one or more hidden surface segments located obstructed from at least one discrete observation location within the observation environment. Further, at least one hidden surface segment of the second part is positioned adjacent and unobstructed from the first part. The machine readable instructions stored in the one or more memory modules further cause the surface analysis system to determine a segment spacing distance between at least one hidden surface segments of the second part and the first part, compare, using the one or more processors, the segment spacing distance with a threshold spacing distance, compare, using the one or more processors, the one or more visible surface segments of the first part with a reference model of the multi-part assembly, and compare, using the one or more processors, the one or more hidden surface segments of the second part that are positioned adjacent and unobstructed from the first part and have a segment spacing distance less than or equal to the threshold spacing distance with the reference model of the multi-part assembly.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an surface analysis system, according to one or more embodiments shown and described herein;

FIG. 2 depicts an example multi-part assembly comprising a vehicle, according to one or more embodiments shown and described herein;

FIG. 3 schematically depicts a cross-section of a first part and a second part of the multi-part assembly of FIG. 2, according to one or more embodiments shown and described herein;

FIG. 4 schematically depicts a comparator surface reference model of the first part and the second part of FIG. 3, according to one or more embodiments shown and described herein;

FIG. 5 depicts a flow diagram of a method of generating a comparator surface reference model using the surface analysis system, according to one or more embodiments shown and described herein;

FIG. 6 schematically depicts a cross-section of a first part and a second part of a second multi-part assembly, according to one or more embodiments shown and described herein;

FIG. 7 schematically depicts part models of the first part and the second part of FIG. 6 overlaid with the comparator surface reference model of FIG. 4, according to one or more embodiments shown and described herein; and

FIG. 8 depicts a flow diagram of a method of comparing surfaces of a multi-part assembly with a reference model of the multi-part assembly using the surface analysis system, according to one or more embodiments shown and described herein.

### DETAILED DESCRIPTION

The embodiments disclosed herein include a surface analysis system for generating a comparator surface reference model of a multi-part assembly, for example, a vehicle. In operation, the surface analysis system identifies visible surface segments of one or more parts and classifies the visible surface segments as comparator surfaces. The visible surface segments comprise the surface segments of the multi-part assembly that are positioned unobstructed from at least one observation location in an observation environment. For example, the at least one observation location may comprise a location where a head of an observer may be positioned at least once during an observation period. The surface analysis system may also classify hidden surface segments of the multi-part assembly that are positioned unobstructed from an adjacent part and located within a threshold segment spacing distance from the adjacent part. Further, the surface analysis system may generate a comparator surface reference model of the comparator surfaces of the multi-part assembly. The comparator surface reference model may be used for quality control and includes only a subset of the multi-part assembly, providing a simple and efficient quality control model for design and manufacture of multi-part assemblies. The surface analysis system and will now be described in more detail herein with specific reference to the corresponding drawings.

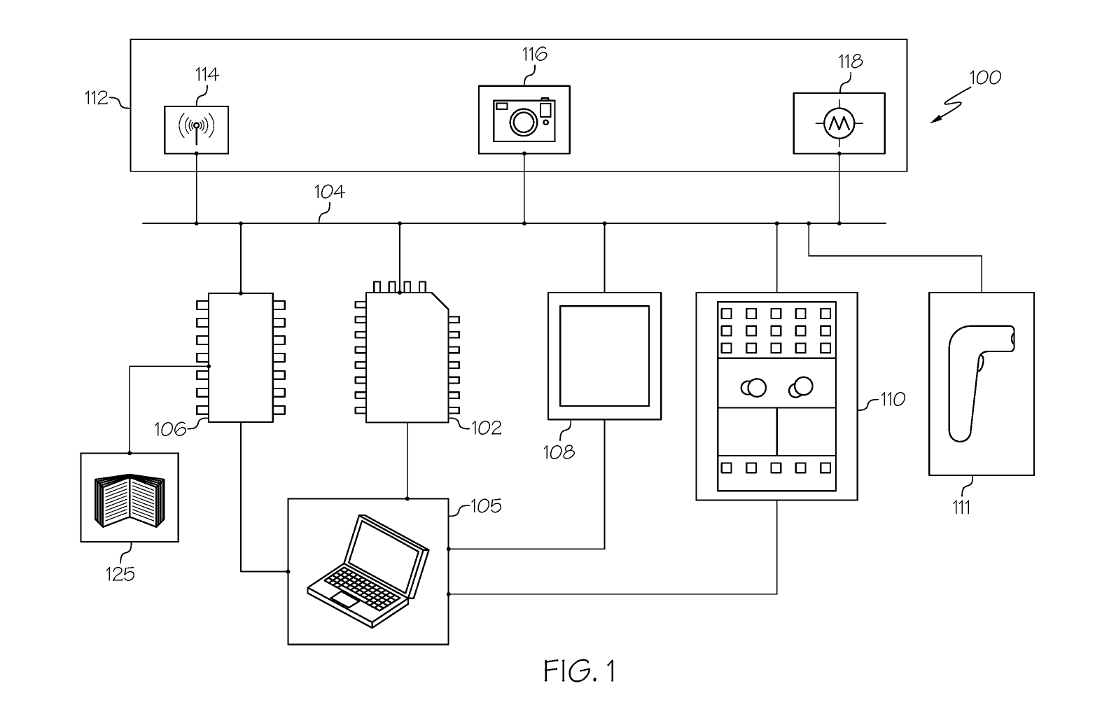

Referring now to FIG. 1, an embodiment of a surface analysis system 100 is schematically depicted. The surface analysis system 100 includes one or more processors 102. Each of the one or more processors 102 may be any device capable of executing machine readable instructions. Accordingly, each of the one or more processors 102 may be a controller, an integrated circuit, a microchip, a computer, or any other processing device. For example, the one or more processors 102 may be processors of a computing device 105. The one or more processors 102 are coupled to a communication path 104 that provides signal interconnectivity between various components of the surface analysis system 100. Accordingly, the communication path 104 may communicatively couple any number of processors 102 with one another, and allow the components coupled to the communication path 104 to operate in a distributed computing environment. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 104 may be formed from any medium that is capable of transmitting a signal such as, for example, conductive wires, conductive traces, optical waveguides, or the like. In some embodiments, the communication path 104 may facilitate the transmission of wireless signals, such as WiFi, Bluetooth, and the like. Moreover, the communication path 104 may be formed from a combination of mediums capable of transmitting signals. In one embodiment, the communication path 104 comprises a combination of conductive traces, conductive wires, connectors, and buses that cooperate to permit the transmission of electrical data signals to components such as processors, memories, sensors (e.g., sensors 112 described herein), input devices, output devices, and communication devices. Accordingly, the communication path 104 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

Moreover, the surface analysis system 100 includes one or more memory modules 106 coupled to the communication path 104. The memory modules 106 may be one or more memory modules of the computing device 105. Further, the one or more memory modules 106 may comprise RAM, ROM, flash memories, hard drives, or any device capable of storing machine readable instructions such that the machine readable instructions can be accessed by the one or more processors 102. The machine readable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the one or more memory modules 106. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

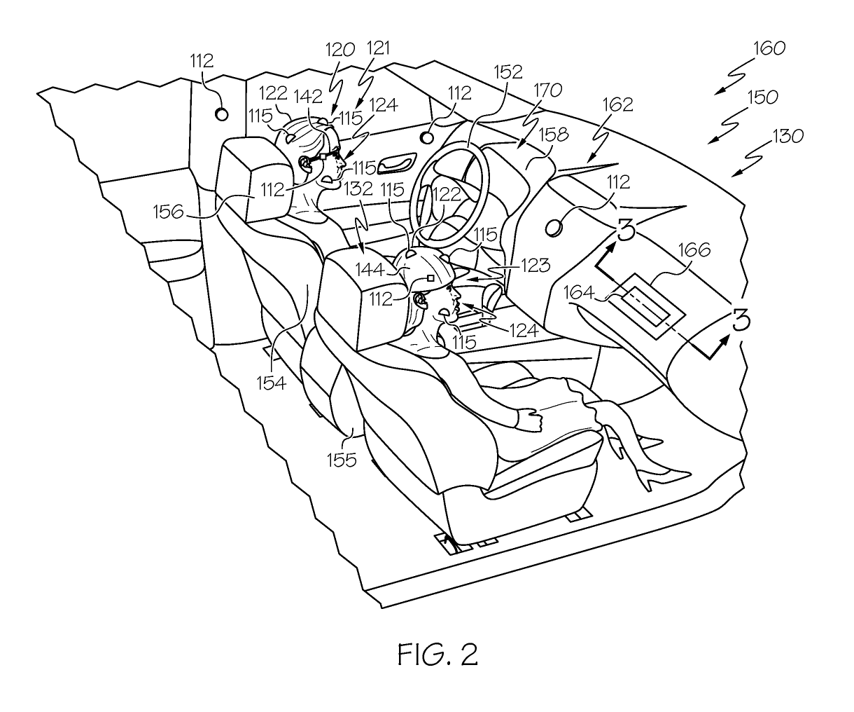

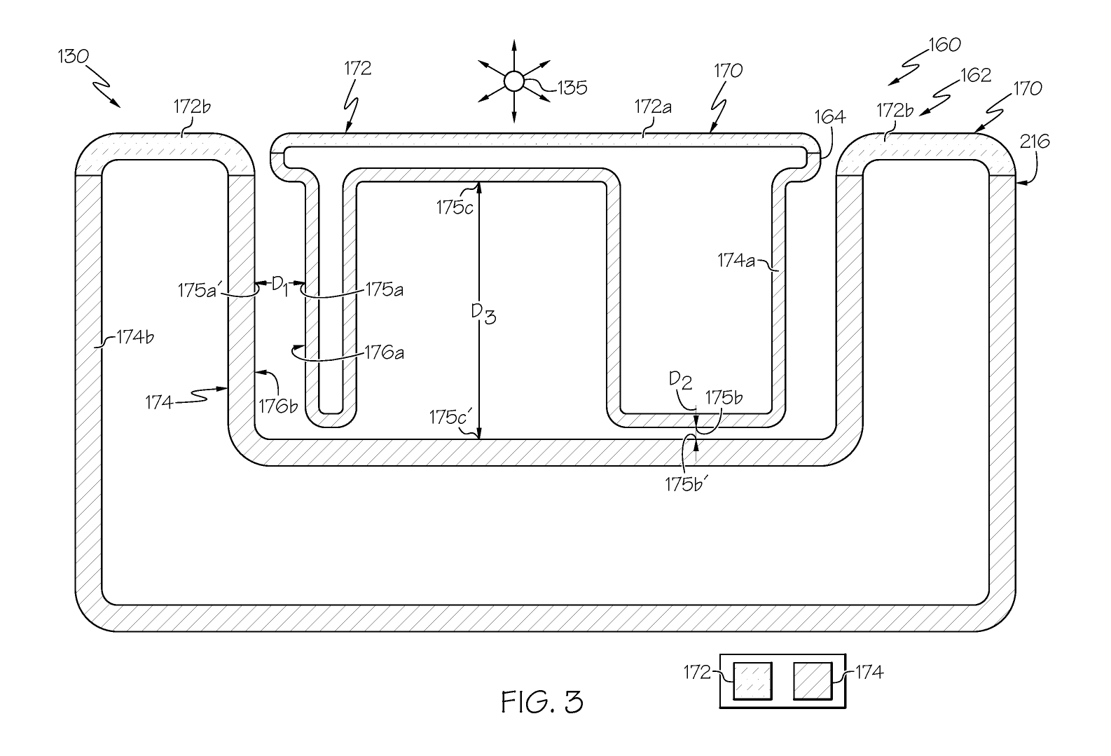

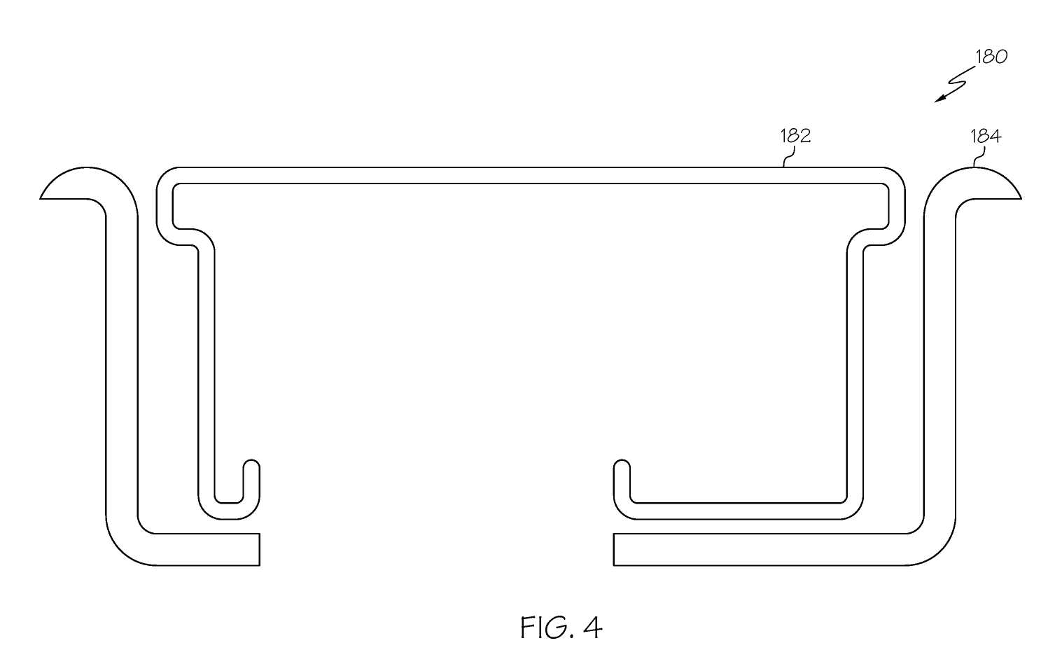

As depicted in FIG. 1, the surface analysis system 100 may include a reference model library 125, which may be stored in the one or more memory modules 106. The reference model library 125 may store one or more reference models corresponding with a multi-part assembly 160 (FIGS. 2 and 3). The reference models stored within the reference model library 125 may comprise two-dimensional reference models (e.g., drawings) and three dimensional reference models. Further, the reference models stored within the reference model library 125 may comprise reference models of both the multi-part assembly 160 and individual parts 162 (FIGS. 2 and 3) of the multi-part assembly 160. Further, reference models, for example, comparator surface reference models 180 (FIG. 4) generated by the surface analysis system 100 may be stored in the reference model library 125. In operation, reference models, such as the comparator surface reference model 180, may be compared with various iterations of the multi-part assembly 160, for example, compared with part models of one or more parts 162 of the various iterations of the multi-part assembly 160 generated by scanning the part 162, for example, using a scanner 111. As used herein “iterations” of the multi-part assembly 160 reference to multiple versions or copies of the same multi-part assembly 160. For example, when the multi-part assembly 160 comprises a vehicle 150 (FIG. 2), each iteration of the vehicle 150 refers to a single vehicle and multiple iterations refer to multiples of the same vehicle 150, e.g., the same make and model of the vehicle 150.

Referring still to FIG. 1, the surface analysis system 100 includes one or more scanners 111 communicatively coupled to the one or more processors 102. The one or more scanners 111 are configured to capture surface data from real-world surfaces, such as surfaces 170 (FIGS. 2 and 3) of the multi-part assembly 160. The surface data may comprise surface contour data. In some embodiments, the one or more scanners 111 may comprise three-dimensional scanners, two-dimensional scanners, or a combination thereof. As a non-limiting example, the one or more scanners 111 may capture surface contour data from one or more surfaces of a vehicle 150 (FIG. 2). The one or more scanners 111 generally capture surface contour data by scanning the targeted surfaces with a scanning sensor (e.g. an optical sensor, a laser, a radar array, or a LiDAR array). From the surface contour data, the one or more processors 102 may execute point cloud logic or other scanning logic to generate a part model of the one or more parts 162 of the multi-part assembly 160. In operation, the part models generated by scanning the one or more surfaces 170 of the parts 162 with the scanners 111 may be compared to the reference models of the reference model library 125, for example, the comparator surface reference model 180.

Referring still to FIG. 1, the surface analysis system 100 comprises a display 108 for providing visual output such as, visual depictions of scanned parts, part models, reference models, or the like. The display 108 is coupled to the communication path 104. Accordingly, the communication path 104 communicatively couples the display 108 to other components of the surface analysis system 100. The display 108 may include any medium capable of transmitting an optical output such as, for example, a cathode ray tube, light emitting diodes, a liquid crystal display, a plasma display, or the like. In some embodiments, the display 108 may comprise a display of the computing device 105. Moreover, the display 108 may be a touchscreen that, in addition to providing optical information, detects the presence and location of a tactile input upon a surface of or adjacent to the display. Accordingly, each display may receive mechanical input directly upon the optical output provided by the display.

The surface analysis system 100 may further comprise tactile input hardware 110 coupled to the communication path 104 such that the communication path 104 communicatively couples the tactile input hardware 110 to other components of surface analysis system 100. The tactile input hardware 110 may be any device capable of transforming mechanical, optical, or electrical signals into a data signal capable of being transmitted with the communication path 104. Specifically, the tactile input hardware 110 may include any number of movable objects that each transform physical motion into a data signal that can be transmitted to over the communication path 104 such as, for example, a button, a switch, a knob, a microphone or the like. Further, in some embodiments, the tactile input hardware 110 may be integrated with and/or connected to the computing device 105.

Referring now to FIGS. 1 and 2, the surface analysis system 100 further comprises one or more sensors 112, for example, one or more of an image sensor 114, a proximity sensor 116, and/or a motion capture sensor 118. In operation, each of the one or more sensors 112 may be configured to generate data regarding a location (e.g., a spatial location) and, in some embodiments, an orientation of an object, for example, a head 122 of an observer 120 positioned in an observation environment 130. In some embodiments, the surface analysis system 100 may further comprise one or more tracking markers 115 configured to be worn by the observer 120. In operation, the one or more tracking markers 115 may interact with the one or more sensors 112 to generate data regarding a location and/or orientation of the observer 120 (e.g., the head 122 of the observer 120).

The image sensor 114 is coupled to the communication path 104 such that the communication path 104 communicatively couples the image sensor 114 to other components of the surface analysis system 100. The image sensor 114 may comprise any imaging device configured to capture image data of the observation environment 130 and the observer 120 positioned in the observation environment 130. The image data may digitally represent at least a portion of the observation environment 130 or the observer 120, for example, the head 122 of the observer 120. In operation, the image sensor 114 may interact with the one or more tracking markers 115 when the one or more tracking markers 115 are worn by the observer 120, to determine the location of the observer 120 (e.g., the spatial location of the head 122 of the observer 120) and, in some embodiments, the orientation of the head 122 of the observer 120 (e.g., a pointing direction of a face 124 of the observer 120).

The image sensor 114 may comprise any sensor operable to capture image data, such as, without limitation, a charged-coupled device image sensors or complementary metal-oxide-semiconductor sensors capable of detecting optical radiation having wavelengths in the visual spectrum, for example. The image sensor 114 may be configured to detect optical radiation in wavelengths outside of the visual spectrum, such as wavelengths within the infrared spectrum. In some embodiments, two or more image sensors 114 are provided to generate stereo image data capable of capturing depth information. Moreover, in some embodiments, the image sensor 114 may comprise a camera, which may be any device having an array of sensing devices (e.g., pixels) capable of detecting radiation in an ultraviolet wavelength band, a visible light wavelength band, or an infrared wavelength band.

Still referring to FIGS. 1 and 2, the proximity sensor 116 is communicatively coupled to the communication path 104 such that the communication path 104 communicatively couples the proximity sensor 116 to other components of the surface analysis system 100. The proximity sensor 116 may be any device capable of outputting a proximity signal indicative of a proximity of an object to the proximity sensor 116. In some embodiments, the proximity sensor 116 may include a laser scanner, a capacitive displacement sensor, a Doppler effect sensor, an eddy-current sensor, an ultrasonic sensor, a magnetic sensor, an optical sensor, a radar sensor, a sonar sensor, or the like. Some embodiments may not include the proximity sensor 116. In operation, the proximity signal may be used to determine the location of the observer 120 and in some embodiments, the orientation of the observer 120. For example, the proximity sensor 116 may interact with the one or more tracking markers 115 when the one or more tracking markers 115 are worn by the observer 120, to determine the location of the observer 120 (e.g., the spatial location of the head 122 of the observer 120) and, in some embodiments, the orientation of the head 122 of the observer 120 (e.g., the pointing direction of the face 124 of the observer 120).

Further, the motion capture sensor 118 is communicatively coupled to the communication path 104 such that the communication path 104 communicatively couples the motion capture sensor 118 to other components of the surface analysis system 100. The motion capture sensor 118 comprises one or more sensors that are wearable by the observer 120 and are configured to measure the spatial location and/or the orientation of the observer 120. For example, the motion capture sensor 118 may comprise an inertial sensor having an inertial measurement unit (IMU). For example, the IMU may include a gyroscope, a magnetometer, and an accelerometer. Further, the motion capture sensor 118 may comprise one or more RF sensors configured to transmit an RF signal regarding the spatial location and/or orientation of the head 122 of the observer 120. Moreover, the motion capture sensor 118 may comprise one or more magnetic sensors configured to transmit a magnetic signal regarding the spatial location and/or orientation of the head 122 of the observer 120.

As depicted in FIG. 2, the one or more sensors 112 and/or one or more tracking markers 115 may be coupled to a wearable device 140 configured to be worn by the observer 120, for example, eyeglasses 142, headwear 144, or any other wearable device configured to monitor the position and/or orientation of the head 122 of the observer 120. Further, the one or more tracking markers 115 may be directly coupled to the observer 120, for example, using an adhesive or a fastening mechanism. As a non-limiting example, the one or more sensors 112, for example, image sensors 114 and/or proximity sensors 116 may be positioned in the observation environment 130 apart from the observer 120 and the one or more tracking markers 115 may be positioned on the head 122 of the observer 120 using the wearable device 140 or by directly coupling the one or more tracking markers 115 to the head 122 of the observer 120. As another non-limiting example, the motion capture sensors 118 may be coupled to the observer 120 and/or the wearable device 140 and may measure the location and/or orientation of the head of the observer 120 without use of additional sensors 112. In operation, the sensors 112 may monitor the observer 120, for example, by monitoring the tracking markers 115 and may generate sensor data regarding the location and or orientation of the head of the observer 120.

Still referring to FIG. 2, an example multi-part assembly 160 comprising a vehicle 150 is depicted. The multi-part assembly 160 may be positioned in the observation environment 130. The multi-part assembly 160 (e.g., the vehicle 150) includes one or more parts 162 each comprising one or more surfaces 170. For example, the one or more parts 162 may comprise one or more vehicle parts positioned in the interior of the vehicle 150, such as a seat 154, a dashboard 158, a steering wheel 152, a central storage console 155, one or more interior panels, a vehicle floor, or the like. Further, the one or more parts 162 may comprise one or more exterior vehicle parts, for example, one or more exterior vehicle panels. While the multi-part assembly 160 is described herein as comprising the vehicle 150 and the one or more surfaces 170 are described as vehicle part surfaces, it should be understood that the surface analysis system 100 may analyze surfaces in any multi-part assembly 160.

Referring also to FIG. 3, a cross-section of two parts 162 of the multi-part assembly 160 is depicted, for example, a first part 164 and a second part 166. The first part 164 and the second part 166 may comprise any two parts of the multi-part assembly 160, such as adjacent parts. As an example, the first part 164 and the second part 166 may comprise two panel portions of the dashboard 158 the vehicle 150. Further, the first part 164 and the second part 166 may be located in the observation environment 130, which comprises one or more discrete observation locations 135. The one or more discrete observation locations 135 are locations within the observation environment 130 from which the observer 120 may view the multi-part assembly 160. When the multi-part assembly 160 comprises the vehicle 150 of FIG. 2, the one or more discrete observation locations 135 may comprise any location within the vehicle 150 or outside the vehicle 150, where the head 122 of the observer 120 may be located.

Referring still to FIG. 3, the parts 162 of the multi-part assembly 160 may each comprise one or more visible surface segments 172 and/or one or more hidden surface segments 174. The one or more visible surface segments 172 are segments of the one or more surfaces 170 that are positioned unobstructed from at least one discrete observation point 135 within the observation environment 130. The one or more hidden surface segments 174 are segments of the one or more surfaces 170 of that are not visible to the observer 120 and may be obstructed from each discrete observation point 135. For example, the one or more hidden surface segments 174 may comprise surface segments that face away from the one or more discrete observation points 135 and/or surface segments that are blocked from view from the one or more discrete observation points 135, e.g., by other parts 162. The visible surface segments 172 and the hidden surface segments 174 may comprise any length. Further, an individual part 162 may comprise both visible surface segments 172 and hidden surface segments 174. For example, the first part 164 comprises first visible surface segments 172a and first hidden surface segments 174a. Further, the second part 166 comprises second visible surface segments 172b and second hidden surface segments 174b. In FIG. 3, the visible surface segments 172 are depicted with a dot-dash crosshatch pattern and the hidden surface segments 174 are depicted with a standard crosshatch pattern.

Further, portions of the hidden surface segments 174 may include interacting hidden surface segments 176 that are positioned unobstructed from an adjacent part 162. For example, first interacting hidden surface segments 176a of the first part 164 comprise portions of the first hidden surface segments 174a of the first part 164 that face the second part 166 without any obstructions positioned therebetween. Further, second interacting hidden surface segments 176b of the second part 166 comprise portions of the second hidden surface segments 174b of the second part 166 that face the first part 164 without any obstructions positioned therebetween. In some embodiments, as described below, the surface analysis system 100 may scan the first part 164 and the second part 166 using the scanner 111 to generate one or more part models of the first part 164 and the second part 166. It is noted that in some embodiments, the one or more processors 102 execute scanning logic to cause the one or more scanners 111 to scan the first part 164 and the second part 166. In other embodiments, the first part 164 and the second part 166 may be manually scanned with the one or more scanners 111. In operation, to determine which of the hidden surface segments 174 comprise interacting hidden surface segments 176, the surface analysis system 100 may generate one or more visibility polygons extending from the one or more portions along the hidden surface segments 174. Moreover, information regarding the interacting hidden surface segments 176 may be stored in the one or more memory modules 106.

Referring now to FIG. 3, the multi-part assembly 160 further comprises segment spacing distances D extending between hidden surface segments 174 and parts 162 positioned adjacent the hidden surface segments 174. For example, the segment spacing distances D may extend between the first hidden surface segments 174a of the first part 164 and the second hidden surface segments 174b of the second part 166. Further, the individual spacing distances D may extend between a discrete measurement location 175 of the first hidden surface segment 174a of the first part 164 and a corresponding discrete measurement location 175′ of the second hidden surface segment 174b of the second part 166. Each segment spacing distance D may extend orthogonal from the discrete measurement location 175 of the hidden surface segment 174 of the first part 164 and the corresponding discrete measurement location 175′ of the second part 166. Further, in some embodiments, the segment spacing distances D may extend outward from each discrete measurement location 175 in a plurality of directions.

As a non-limiting example, FIG. 3 depicts three segment spacing distances D extending between three discrete measurement locations 175, 175′ of the first part 164 and the second part 166. A first segment spacing distance D₁ extends between a first discrete measurement location 175a of the first part 164 and a first corresponding discrete measurement location 175a′ of the second part 166. A second segment spacing distance D₂ extends between a second discrete measurement location 175b of the first part 164 and a second corresponding discrete measurement location 175b′ of the second part 166. Further, a third segment spacing distance D₃ extends between a third discrete measurement location 175c and a third corresponding discrete measurement location 175c′ of the second part 166. While the segment spacing distance D is depicted at three discrete measurement locations 175, 175′, it may be desired to determine the segment spacing distance D along a continuous length of each of the hidden surface segments 174.

Referring now to FIG. 4, an example comparator surface reference model 180 of the multi-part assembly 160 is depicted. The comparator surface reference model 180 comprises a first comparator reference surface 182 corresponding with surfaces 170 of the first part 164 and a second comparator reference surface 184 corresponding with the surfaces 170 of the second part 166. In particular, the comparator surface reference model 180 is a reference model of one or more comparator surfaces of the multi-part assembly 160. Comparator surfaces are a subset of the surfaces 170 of the multi-part assembly 160 that meet preset criteria. For example, the comparator surfaces may comprise the visible surface segments 172 of the one or more parts 162 of the multi-part assembly 160 and interacting hidden surface segments 176 of the hidden surface segments 174 that comprise a segment spacing distance D that is less than a threshold segment spacing distance. In operation, when comparing the multi-part assembly 160 to a reference model, it may be efficient to generate comparator surface reference models 180 of the multi-part assembly 160 that comprise comparator reference surfaces 182, 184 corresponding with the surfaces 170 of the multi-part assembly 160 that meet the criteria of a comparator surface. Moreover, it may be efficient to compare only a portion of the surfaces 170 of the multi-part assembly 160 to the reference model, for example, compare only the surfaces 170 of the multi-part assembly 160 that meet the criteria of a comparator surface with the reference model.

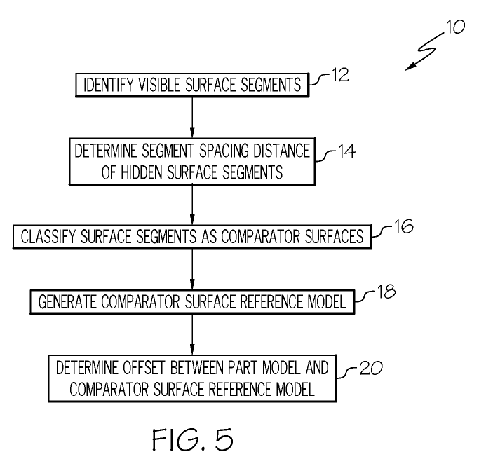

Referring also to FIG. 5 a flow chart 10 depicting a method for generating the comparator surface reference model 180 of the multi-part assembly 160 is illustrated. The flow chart 10 depicts a number of method steps illustrated by boxes 12-20. Though the method is described below with respect to the first part 164 and the second part 166, the method may be used to generate comparator surface reference models 180 of any multi-part assembly 160 having any number of parts 162. Further, while the steps of the method are described below in a particular order, it should be understood that other orders are contemplated.

Referring now to FIGS. 1-5, at box 12, the method for generating the comparator surface reference model 180 includes first identifying one or more visible surface segments 172. In some embodiments, the one or more visible surface segments 172 may be identified by monitoring the observer 120 positioned in the observation environment 130 using the one or more sensors 112. As depicted in FIG. 2, the observer 120 may be the driver 121 of the vehicle 150 or the passenger 123 of the vehicle 150. In operation, the one or more sensors 112 may monitor the observer 120 for an observation period, measure one or more locations of the head 122 of the observer 120 within the observation environment 130 and, in some embodiments, measure the orientation of the head 122 of the observer 120 within the observation environment 130. Each measured location of the head 122 of the observer 120 may correspond with an individual discrete observation point 135 within the observation environment 130.

Using this head location data, the one or more processors 102 may identify the visible surface segments 172. In particular, the visible surface segments 172 comprise the surfaces 170 of the one or more parts 162 that are positioned unobstructed from at least one discrete observation point 135. Non-limiting example methods and systems for identifying the one or more visible surface segments 172 are described in U.S. application Ser. No. 15/221,012 titled “Surface Analysis Systems and Methods of Identifying Visible Surfaces Using the Same,” filed Jul. 27, 2016, hereby incorporated by reference.

In some embodiments, the visible surface segments 172 may be identified based on surface data stored in the one or more memory modules 106. The visible surface segments 172 may also be identified based on user input received by the tactile input hardware 110. Further, the visible surface segments 172 may be identified by the one or more sensors 112 without monitoring the observer 120. For example, the one or more sensors 112 may scan or otherwise generate surface data of the multi-part assembly 160 based on sensor signals and output sensor data to the one or more processors 102. The one or more processors 102 may use the sensor data to determine the one or more visible surface segments 172. The remaining surfaces 170 of the first part 164 and the second part 166 comprise the one or more hidden surface segments 176.

Next, at box 14, the surface analysis system 100 may determine the segment spacing distance D between the one or more hidden surface segments 174 of the first part 164 and the second part 166. For example, by scanning each part 162 with the scanner 111 to generate a part model of each part 162 and/or by accessing data regarding the one or more parts 162 stored in the one or more memory modules 106. The segment spacing distance D may be measured and determined at the plurality of discrete measurement locations 175, 175′, which may be spaced along the surfaces 170 of the first part 164 and the second part 166 between about 0.05 mm and about 10 cm apart. In some embodiments, the segment spacing distance D may be measured along a continuous length of each of the hidden surface segments 174. Further, the segment spacing distance D, for example, the first segment spacing distance D₁, the second segment spacing distance D₂, and the third segment spacing distances D₃, may be compared to the threshold segment spacing distance. The threshold spacing distance may be preset and stored in the one or more memory modules 106. The threshold segment spacing distance may comprise any preset distance, for example, between about 0.05 cm and about 50 cm, for example, 0.1 cm 0.25 cm, 0.5 cm, 0.75 cm, 1 cm, 2 cm, 5 cm, 10 cm, 25 cm, or the like. For example, in some embodiments, the threshold spacing distance may comprise less than about 10 cm, less than about 5 cm, less than about 2 cm, less than about 1 cm, less than 0.5 cm, less than 0.1 cm or the like.

Next, at box 16 the surface analysis system 100 may classify segments of the surfaces 170 as comparator surfaces. In particular, the surface analysis system 100 may classify the one or more visible surface segments 172 as comparator surfaces, for example, the first visible surface segments 172a of the first part 164 and the second visible surface segments 172b of the second part 166. Further, the surface analysis system 100 may classify the one or more hidden surface segments 174 that are positioned unobstructed from an adjacent part (e.g., interacting hidden surface segments 176a, 176b of the first part 164 and the second part 166) and comprise a segment spacing distance D that is less than or equal to the threshold spacing distance, as comparator surfaces. In the example depicted in FIG. 3, the first segment spacing distance D₁ and the second segment spacing distance D₂ are less than the threshold spacing distance and the third segment spacing distance D₃ is greater than the threshold spacing distance. As such, the hidden surface segments 174 at the first discrete measurement locations 175a 175a′ of the first part 164 and the second part 166 are comparator surfaces and the hidden surface segments 174 at the second discrete measurement locations 175b, 175b′ of the first part 164 and the second part 166 are classified as comparator surfaces. However, hidden surface segments 174 at the third discrete measurement locations 175c 175c′ of the first part 164 and the second part 166 are not classified as comparator surfaces.

At box 18, surface analysis system 100 may generate a comparator surface reference model 180 corresponding with the multi-part assembly 160. As depicted in FIG. 4, the comparator surface reference model 180 comprises a first comparator reference surface 182 corresponding with the comparator surfaces of the first part 164 and a second comparator reference surface 184 corresponding with the comparator surfaces of the second part 166. In some embodiments, the comparator surface reference model 180 comprises a two-dimensional representation of the comparator surfaces of the multi-part assembly 160 and in other embodiments, the comparator surface reference model 180 comprises a three-dimensional representation of the comparator surfaces of the multi-part assembly 160.

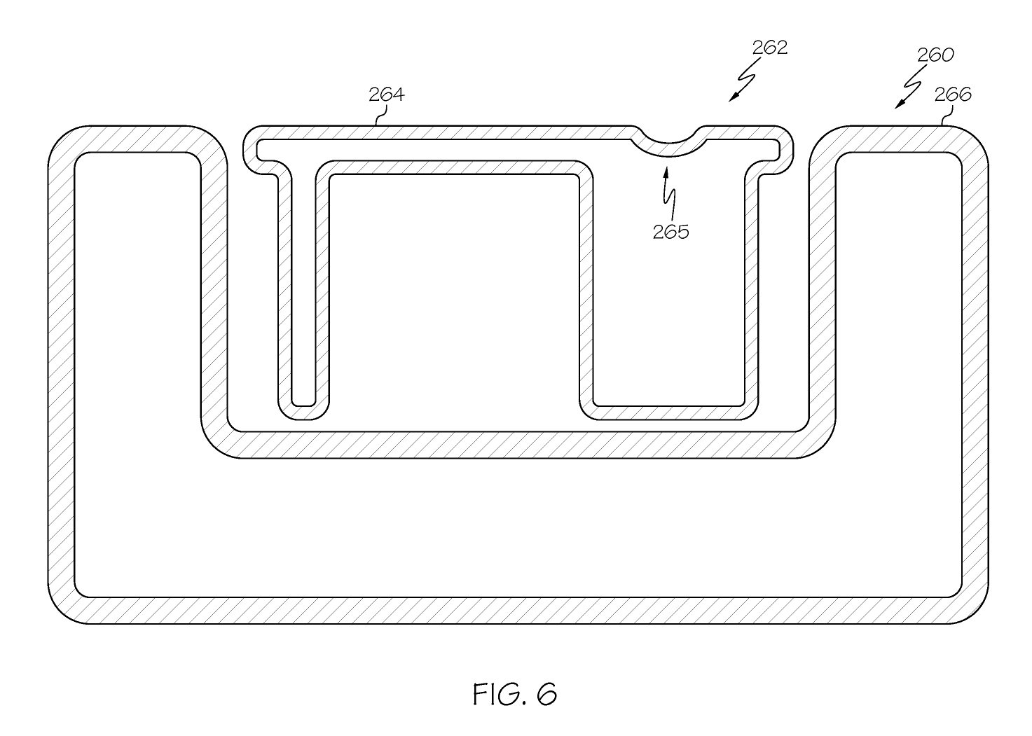

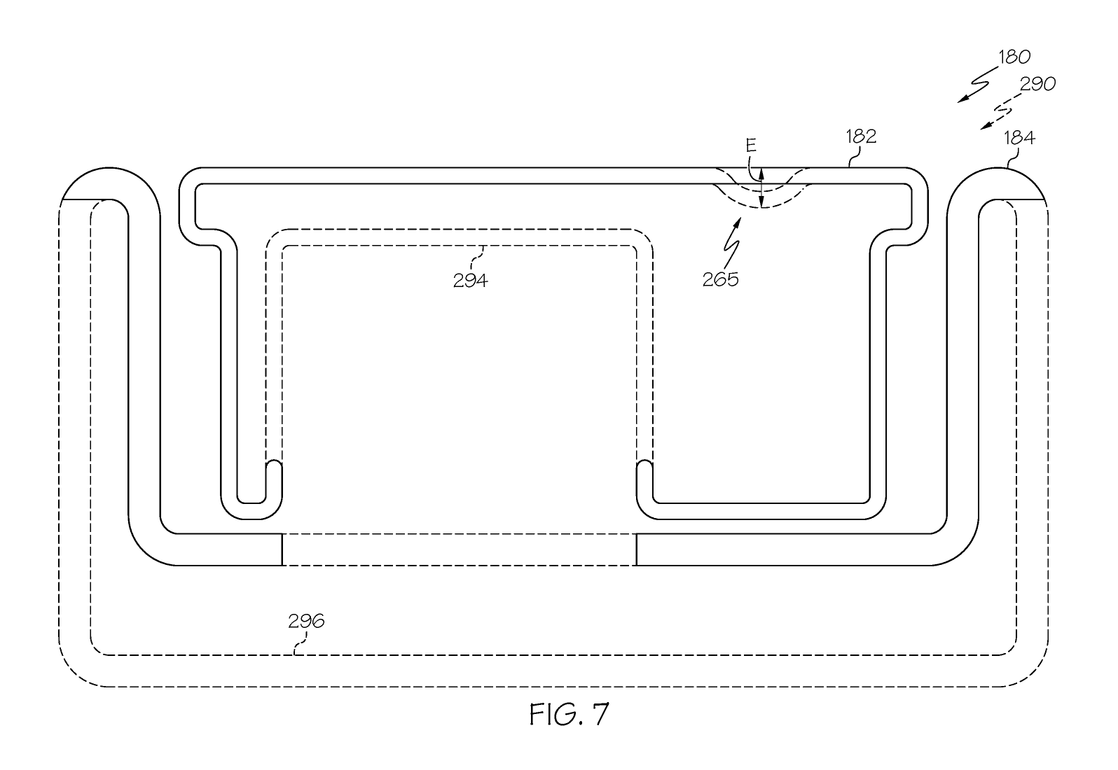

Further, at box 20, the surface analysis system 100 may use the comparator surface reference model 180 to analyze additional multi-part assemblies 160. In operation, the surface analysis system 100 may compare the comparator surface reference model 180 of the multi-part assembly 160 with additional iterations of the multi-part assembly 160, for example, to determine one or more offsets 265 (FIGS. 6 and 7) between each multi-part assembly 160 and the comparator surface reference model 180. This comparison may be used for quality control. Referring now to FIGS. 6 and 7, a second multi-part assembly 260 comprising one or more parts 262 including a first part 264 and a second part 266 is depicted. The second multi-part assembly 260 comprises an additional iteration of the multi-part assembly 160 of FIG. 3. Further, as depicted in FIG. 6, the second multi-part assembly 260 may comprise the one or more offsets 265, which comprise one or more segments of the surface of the first part 264 and/or the second part 266 that deviate from the reference model of the multi-part assembly 160, for example, the comparator surface reference model 180. The one or more offsets 265 may be indicative of one or more flaws in the second multi-part assembly 260. While the one or more offsets 265 are described with respect to the example second multi-part assembly 260, it should be understood that any iteration of the multi-part assembly 160 may comprise the one or more offsets 265.

In operation, the first part 264 and the second part 266 of the second multi-part assembly 260 may be scanned using the scanner 111 to generate scanning data, which may be output to the one or more processors 102. As depicted in FIG. 7, based on the scanning data, the one or more processors 102 may generate a first part model 294 of the first part 264 and a second part model 296 of the second part 266. Further, the surface analysis system 100 may compare the first part model 294 and the second part model 296 with the comparator surface reference model 180 to determine the one or more offsets 265 between the second multi-part assembly 260 and the comparator surface reference model 180. In some embodiments, the surface analysis system 100 may also determine a maximum deviation E of each of the one or more offsets 265.

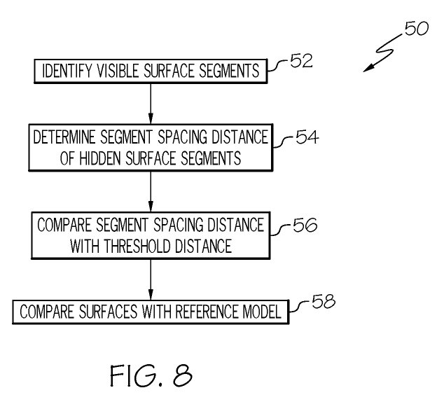

Referring now to FIG. 8, a flow chart 50 depicting a method for comparing the one or more surfaces 170 of the multi-part assembly 160 with a reference model is illustrated. The flow chart 50 depicts a number of method steps illustrated by boxes 52-58. In the method depicted by flow chart 50, the surface analysis system 100 may determine the surfaces 170 of the multi-part assembly 160 to identify and classify as comparator surfaces, using the methods and criteria described above with respect to the flow chart 10 of FIG. 5. Once the comparator surfaces have been identified, the comparator surfaces may be compared to a reference model of the multi-part assembly 160, for example, a reference model of the full multi-part assembly 160.

At box 52, the method includes first identifying one or more visible surface segments 172, as described above with respect to FIG. 5. Next, at box 54, the surface analysis system 100 may determine the segment spacing distance D between the one or more hidden surface segments 174 of the first part 164 and the second part 166, as described above with respect to FIG. 5. At box 56, the segment spacing distance D may be compared to the threshold segment spacing distance. Next, the surface analysis system 100 may classify the visible surface segments 172 and the one or more hidden surface segments 174 that are positioned unobstructed from an adjacent part (e.g., interacting hidden surface segments 176a, 176b of the first part 164 and the second part 166) and comprise a segment spacing distance D that is less than or equal to the threshold spacing distance, as comparator surfaces.

Further, at box 58, the surface analysis system 100, for example, the one or more processors 102, may compare the surfaces 170 that meet the criteria of comparator surfaces, (e.g., the visible surface segments 172 and the hidden surface segments 174 that are unobstructed from an adjacent part 162 and have a segment spacing distance D that is less than or equal to the threshold spacing distance) with the reference model, for example, a reference model of the full multi-part assembly 160. In some embodiments, part models of the surfaces 170 that meet the criteria of comparator surfaces may be generated, for example, using the scanner 111, and these part models may be compared with the reference model of the full multi-part assembly 160 to determine the one or more offsets 265 between the surfaces 170 of the multi-part assembly 160 classified as comparator surfaces and the reference model. In this method, instead of generating the comparator surface reference model 180 to increase quality control efficiency, the surface analysis system 100 compares the surfaces 170 of the multi-part assembly 160 that are classified as comparator surfaces with the reference model of the full multi-part assembly 160 to provide a different method of increasing quality control efficiency.

It should be understood that embodiments described herein provide for surface analysis systems and methods for a comparator surface reference model corresponding with the one or more comparator surfaces of a multi-part assembly. In operation, the surface analysis system may identify one or more visible surface segments of a first part of a multi-part assembly and classify the one or more visible surface segments as comparator surfaces. The surface analysis system may also classify one or more hidden surface segments positioned unobstructed from an adjacent part and comprising a segment spacing distance from the adjacent part as comparator surfaces. Once the comparator surfaces have been identified, the surface analysis system may generate the comparator surface reference model. The comparator surface reference model provides an efficient model for quality control. For example, the surface analysis system may compare additional iterations of the multi-part assembly to the comparator surface reference model to determine deviations between the comparator surface reference model and the additional iterations of the multi-part assembly.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A surface analysis system comprising:
one or more processors;
one or more memory modules communicatively coupled to the one or more processors; and
machine readable instructions stored in the one or more memory modules that cause the surface analysis system to perform at least the following when executed by the one or more processors:
identify one or more visible surface segments of a first part of a first multi-part assembly, wherein:
the one or more visible surface segments of the first part are located unobstructed from at least one discrete observation location within an observation environment;
the second part comprises one or more hidden surface segments located obstructed from at least one discrete observation location within the observation environment; and
at least one hidden surface segments of the second part is positioned adjacent and unobstructed from the first part;
classify the one or more visible surface segments of the first part as comparator surfaces of the first multi-part assembly;
determine a segment spacing distance between at least one hidden surface segment of the second part and the first part;
classify the one or more hidden surface segments of the second part positioned adjacent and unobstructed from the first part that have a segment spacing distance less than or equal to a threshold spacing distance as one or more comparator surfaces of the first multi-part assembly; and
generate a comparator surface reference model corresponding with the one or more comparator surfaces of the first multi-part assembly.

2. The surface analysis system of claim 1, further comprising a scanner communicatively coupled to the one or more processors, wherein the machine readable instructions stored in the one or more memory modules cause the surface analysis system to perform at least the following when executed by the one or more processors:
generate, using the scanner, a first part model corresponding with a first part of a second multi-part assembly; and
compare, using the one or more processors, the first part model of the second multi-part assembly with the comparator surface reference model.

3. The surface analysis system of claim 2, wherein the machine readable instructions stored in the one or more memory modules cause the surface analysis system to perform at least the following when executed by the one or more processors:
determine an offset between the first part model and the comparator surface reference model.

4. The surface analysis system of claim 2, wherein the machine readable instructions stored in the one or more memory modules cause the surface analysis system to perform at least the following when executed by the one or more processors:
generate, using the scanner communicatively coupled to the one or more processors, a second part model corresponding with a second part of the second multi-part assembly; and
compare, using the one or more processors, the second part model of the second multi-part assembly with the comparator surface reference model.

5. The surface analysis system of claim 4, wherein the machine readable instructions stored in the one or more memory modules cause the surface analysis system to perform at least the following when executed by the one or more processors:
determine an offset between the second part model and the comparator surface reference model.

6. The surface analysis system of claim 1, wherein the first multi-part assembly comprises two or more vehicle parts.

7. The surface analysis system of claim 1, wherein at least one hidden surface segment of the second part of the first multi-part assembly is positioned adjacent and unobstructed from a hidden surface segment of the first part of the first multi-part assembly.

8. The surface analysis system of claim 1, wherein the threshold spacing distance comprises less than about 2 cm.

9. The surface analysis system of claim 1, further comprising a sensor communicatively coupled to the one or more processors.

10. The surface analysis system of claim 9, wherein the one or more visible surface segments of the first part of the first multi-part assembly are identified by
measuring a plurality of head locations of a head of an observer within the observation environment during an observation period using the sensor, wherein:
the plurality of head locations correspond with a plurality of discrete observation locations; and
the sensor is configured to generate data regarding a head location of the head of the observer during the observation period; and
identifying the one or more visible surface segments of the first part based on the plurality of head locations measured during the observation period, wherein the one or more visible surface segments comprise one or more portions of the first part that are positioned unobstructed from at least one head location of the observer during the observation period.

11. The surface analysis system of claim 9, wherein the sensor comprises an image sensor, a motion capture sensor, a proximity sensor, or combinations thereof.

12. A method of generating a comparator surface reference model of a first multi-part assembly, the method comprising:
identifying one or more visible surface segments of a first part of a first multi-part assembly, wherein:
the one or more visible surface segments of the first part are located unobstructed from at least one discrete observation location within an observation environment;
the second part comprises one or more hidden surface segments located obstructed from at least one discrete observation location within the observation environment; and
at least one hidden surface segment of the second part is positioned adjacent and unobstructed from the first part;
classifying the one or more visible surface segments of the first part as one or more comparator surfaces of the first multi-part assembly;
determining a segment spacing distance between at least one hidden surface segments of the second part and the first part;
classifying the one or more hidden surface segments of the second part positioned adjacent and unobstructed from the first part that have a segment spacing distance less than or equal to a threshold spacing distance as one or more comparator surfaces of the first multi-part assembly; and
generating, using one or more processors, a comparator surface reference model corresponding with the one or more comparator surfaces of the first multi-part assembly.

13. The method of claim 12, further comprising:
scanning, using a scanner communicatively coupled to the one or more processors, a first part of a second multi-part assembly;
generating, using the one or more processors, a first part model corresponding with the first part of the second multi-part assembly; and
comparing, using the one or more processors, the first part model of the second multi-part assembly with the comparator surface reference model.

14. The method of claim 13, further comprising determining an offset between the first part model and the comparator surface reference model.

15. The method of claim 12, wherein the first multi-part assembly comprises two or more vehicle parts.

16. The method of claim 12, further comprising a sensor communicatively coupled to the one or more processors and configured to generate data regarding a location of an object, wherein the one or more visible surface segments are identified using the sensor.

17. A surface analysis system comprising:
one or more processors;
one or more memory modules communicatively coupled to the one or more processors; and
machine readable instructions stored in the one or more memory modules that cause the surface analysis system to perform at least the following when executed by the one or more processors:
identify one or more visible surface segments of a first part of a multi-part assembly that further comprises a second part, wherein:
the one or more visible surface segments of the first part are located unobstructed from at least one discrete observation location within an observation environment;
the second part comprises one or more hidden surface segments located obstructed from at least one discrete observation location within the observation environment; and
at least one hidden surface segment of the second part is positioned adjacent and unobstructed from the first part;
determine a segment spacing distance between at least one hidden surface segments of the second part and the first part; and
compare, using the one or more processors, the segment spacing distance with a threshold spacing distance;
compare, using the one or more processors, the one or more visible surface segments of the first part with a reference model of the multi-part assembly; and
compare, using the one or more processors, the one or more hidden surface segments of the second part that are positioned adjacent and unobstructed from the first part and have a segment spacing distance less than or equal to the threshold spacing distance with the reference model of the multi-part assembly.

18. The surface analysis system of claim 17, wherein the multi-part assembly comprises two or more vehicle parts.

19. The surface analysis system of claim 17, further comprising a scanner, wherein the machine readable instructions stored in the one or more memory modules cause the surface analysis system to perform at least the following when executed by the one or more processors:
generate, using the scanner communicatively coupled to the one or more processors, a first part model corresponding with the one or more visible surface segments of the first part;
generate, using the scanner communicatively coupled to the one or more processors, a second part model corresponding with the one or more hidden surface segments of the second part that are positioned adjacent and unobstructed from the first part and have a segment spacing distance less than or equal to the threshold spacing distance;
compare the first part model of the first part with the reference model of the multi-part assembly; and
compare the second part model of the second part with the reference model of the multi-part assembly.

20. The surface analysis system of claim 19, wherein the machine readable instructions stored in the one or more memory modules cause the surface analysis system to perform at least the following when executed by the one or more processors:
determine an offset between the first part model and the reference model; and
determine an offset between the second part model and the reference model.
